(19) United States
(12) Patent Application Publication
(10) Pub. No.: US 2016/0319116 A1
(43) Pub. Date: Nov. 3, 2016

(54) TIRE TREAD

(71) Applicants: COMPAGNIE GENERALE DES ETABLISSEMENTS MICHELIN, Clermont-ferrand (FR); MICHELIN RECHERCHE ET TECHNIQUE S.A., Granges-paccot (CH)

(72) Inventors: PHILIPPE LABRUNIE, Clermont-Ferrand (FR); BENOÏT DE GAUDEMARIS, Clermont-Ferrand (FR)

(21) Appl. No.: 15/103,139

(22) PCT Filed: Dec. 9, 2014
(86) PCT No.: PCT/EP2014/077027

§ 371 Date: Jun. 9, 2016

(30) Foreign Application Priority Data
Dec. 10, 2013 (FR) 1362332

(51) Int. Cl. C08L 15/00; B60C 1/00

(52) U.S. Cl. CPC C08L 15/00; B60C 1/0016

(57) ABSTRACT

The present invention relates to a tire tread that comprises a rubber composition based on at least: an elastomer matrix comprising more than 50 wt % of a first diene elastomer bearing a silanol function and a pendent amine function; a silica at a level between 120 and 140 phr; a coupling agent; and a plasticizer system comprising a hydrocarbon-containing resin having a Tg above 20° C. according to a content A ranging from 5 to 60 phr, a hydrocarbon-containing resin having a Tg above 20° C. and a liquid plasticizer according to a content B ranging from 0 to 60 phr, a liquid plasticizer, it being understood that the total level A+B is at least equal to 60 phr, preferably ranging from 60 to 90 phr. The tread according to the invention makes it possible to improve the compromise between wet grip and dry grip of a tire with low rolling resistance.

The field of the invention is that of rubber compositions for tyres, more precisely rubber compositions for tyre tread.

As is well known, a tyre tread must meet a large number of technical requirements, which are often contradictory, including low rolling resistance, high wear resistance, as well as high grip on dry and wet roads.

In recent years it has been possible to improve this compromise of properties, in particular with regard to rolling resistance and wear resistance, on “Green Tyres” with low energy consumption, notably intended for passenger vehicles, notably through the use of new low-hysteresis rubber compositions having the feature that they are reinforced predominantly with special inorganic fillers described as reinforcing fillers, notably so-called highly dispersible silicas “HDSs”, capable of competing, from the standpoint of the reinforcing capacity, with conventional carbon blacks of tyre grade.

The use of high levels of silica and plasticizer in a low-hysteresis rubber composition based on diene elastomer that is functional and interactive with respect to silica is described in patent application WO 2012/069567. Such a rubber composition can endow a tyre that contains a tread comprising such a rubber composition with an improved compromise with respect to rolling resistance and wet grip. However, the use of a low-hysteresis rubber composition may be accompanied by a reduction in dry grip performance, since the hysteresis potential of the rubber composition has been reduced. That is why improvement of the grip properties, both in the dry and in the wet, of tyres with low rolling resistance is still a constant preoccupation of tyre designers.

Continuing their research, the Applicants discovered, unexpectedly, that the specific choice of an elastomer that is functional and interactive with respect to silica, with a certain amount of silica combined with a specific choice of plasticizer system, makes it possible to obtain an improved compromise of performance with respect to dry grip and wet grip of a tyre with low rolling resistance.

Thus, the invention relates to a tyre tread that comprises a rubber composition based on at least:
an elastomer matrix comprising more than 50 wt % of a first diene elastomer bearing a silanol function and a pendent amine function;
a silica at a level between 120 and 140 phr;
a coupling agent;
a plasticizer system comprising:
   according to a content A ranging from 5 to 60 phr, a hydrocarbon-containing resin having a Tg above 20° C.;
   according to a content B ranging from 0 to 60 phr, a liquid plasticizer;
   it being understood that the total level A+B is at least equal to 60 phr, preferably from 60 to 90 phr.

The invention also relates to a tyre that comprises a tread as defined above.

The invention also relates to a method for making a tread according to the invention.

The tyres of the invention are intended in particular for equipping motor vehicles of the passenger type, including 4×4 vehicles (with four driving wheels) and SUVs (“Sport Utility Vehicles”), as well as two-wheeled vehicles (notably motorbikes).

The invention and its advantages will be easily understood in light of the description and the embodiment examples given below.

### I—DETAILED DESCRIPTION OF THE INVENTION

In the present description, unless expressly stated otherwise, all the percentages (%) indicated are percentages by weight (wt %). The abbreviation “phr” signifies parts by weight per hundred parts of the elastomer matrix that consists in its entirety of the elastomers present in the rubber composition. All the values for the glass transition temperature “Tg” are measured in a known way by DSC (Differential Scanning Calorimetry) according to standard ASTM D3418 (1999).

Moreover, any range of values denoted by the expression “between a and b” represents the range of values from more than a to less than b (i.e. excluding the limits a and b) whereas any range of values denoted by the expression “from a to b” signifies the range of values from a to b (i.e. including the strict limits a and b).

I-1. Diene Elastomer

Elastomer (or loosely “rubber”, the two terms being regarded as synonyms) of the “diene” type is to be understood in a known manner as an (meaning one or more) elastomer derived at least partly (i.e. a homopolymer or a copolymer) from diene monomers (monomers bearing two carbon-carbon double bonds, conjugated or not).

These diene elastomers may be classified in two categories: “essentially unsaturated” or “essentially saturated”. “Essentially unsaturated” generally means a diene elastomer derived at least partly from conjugated diene monomers, having a level of units of diene origin (conjugated dienes) that is greater than 15% (mol %); thus, diene elastomers such as butyl rubbers or copolymers of dienes and of alpha-olefins of the EPDM type are not included in the preceding definition and may notably be qualified as “essentially saturated” diene elastomers (low or very low level of units of diene origin, always below 15%). In the category of “essentially unsaturated” diene elastomers, “strongly unsaturated” diene elastomer means in particular a diene elastomer having a level of units of diene origin (conjugated dienes) that is greater than 50%.

Although it applies to any type of diene elastomer, a person skilled in the art of tyres will understand that the invention is preferably carried out with essentially unsaturated diene elastomers.

These definitions being given, diene elastomer usable in the compositions according to the invention notably means:
(a) any homopolymer obtained by polymerization of a conjugated diene monomer, preferably having from 4 to 12 carbon atoms;
(b) any copolymer obtained by copolymerization of one or more conjugated dienes with one another or with one or more vinyl aromatic compounds preferably having from 8 to 20 carbon atoms.

Suitable conjugated dienes are notably butadiene-1,3, 2-methyl-1,3-butadiene, the 2,3-di(C₁-C₅ alkyl)-1,3-butadienes such as for example 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene, 2,4-hexadiene. Suitable vinyl aromatic compounds are for example styrene, ortho-, meta-, para-methylstyrene, the “vinyl-toluene” commercial mixture, para-tert-butylstyrene, the methoxystyrenes, chlorostyrenes, vinyl mesitylene, divinylbenzene, vinyl naphthalene.

According to one embodiment of the invention, the first diene elastomer is an SBR, preferably a solution SBR.

According to this embodiment of the invention, the glass transition temperature, Tg, of the copolymer of diene and vinyl aromatic, in particular styrene, is advantageously between −55° C. and −40° C.

In general, a function carried by a diene elastomer may be situated on the elastomer chain either at chain end or within the chain (i.e. away from the chain ends). The first case occurs for example when the diene elastomer is prepared using a polymerization initiator bearing the function or using a functionalizing agent. The second case occurs for example when the diene elastomer is modified by the use of a coupling agent or star-branching agent bearing the function.

According to a preferred embodiment of the invention, the silanol function and the pendent amine function are situated away from the chain ends of the first diene elastomer.

The amine function carried by the first diene elastomer is a pendent group. The pendent position of the amine function signifies, as is known, that the nitrogen atom of the amine function is not inserted between the carbon-carbon bonds of the elastomer chain of the first diene elastomer.

According to a first variant of the invention, the silanol function carried by the first diene elastomer is a pendent group, which is equivalent to saying that the silicon atom of the silanol function is not inserted between the carbon-carbon bonds of the elastomer chain of the first diene elastomer. A diene elastomer bearing a pendent silanol function may for example be prepared by hydrosilylation of the elastomer chain by a silane bearing an alkoxysilane group, followed by hydrolysis of the alkoxysilane function into a silanol function.

According to a second variant of the invention, the silanol function carried by the first diene elastomer is not a pendent group, but is situated in the elastomer chain, which is equivalent to saying that the silicon atom of the silanol function is inserted between the carbon-carbon bonds of the elastomer chain of the first diene elastomer. Such a diene elastomer may be prepared by a coupling reaction of the elastomer chains with a coupling agent bearing an alkoxysilane function and an amine function, followed by hydrolysis of the alkoxysilane function into a silanol function. Suitable coupling agents are for example N,N-dialkylaminopropyltrialkoxysilanes, the dialkyl groups being of C1-C10, preferably of C1-C4, the compounds 3 -(N,N-dimethylaminopropyl)trimethoxysilane, 3-(N,N-dimethylaminopropyl)triethoxysilane, 3-(N,N-diethylaminopropyl)trimethoxysilane, 3-(N,N-diethylaminopropyl)triethoxysilane being more particularly preferred whatever the embodiment of the invention. This second variant is preferred and applies to any embodiment of the invention.

According to the first or second variant, hydrolysis of the alkoxysilane function carried by a diene elastomer into a silanol function may be carried out by the procedure described in patent application EP 2 266 819 A1 or else by a step of stripping the solution containing the diene elastomer.

According to a preferred embodiment of the invention, the amine function is a tertiary amine. As tertiary amine function, we may mention the amines substituted with C1-C10 alkyl radicals, preferably C1-C4 alkyl, more preferably a methyl or ethyl radical, whatever the embodiment of the invention.

According to a particularly preferred embodiment of the invention, the first diene elastomer is predominantly in a linear form, i.e. if it comprises star or branched chains, the latter represent a minority weight fraction in this elastomer, i.e. the amount of star chains and of branched chains present in the first diene elastomer is in a range from 0 wt % to less than 50 wt % of the total weight of the first diene elastomer.

It is to be understood that the first diene elastomer may consist of a mixture of elastomers that differ from one another by the chemical nature of the amine function, by their microstructure or by their macrostructure.

When the elastomer matrix of the composition of the tread according to the invention comprises a second elastomer, this second elastomer is a diene elastomer. The second diene elastomer is different from the first diene elastomer in that it does not bear both a silanol function and a pendent amine function. Nevertheless, this second elastomer may have a microstructure or a macrostructure that may be identical to or different from those of the first diene elastomer. It is used in a proportion between 0 and 50%, preferably between 0 and 25%, more preferably between 0 and 10%. In other words the elastomer matrix comprises more than 50 wt %, preferably more than 75 wt %, more preferably more than 90 wt % of the first diene elastomer, the complement to 100% consisting of a second diene elastomer.

The second diene elastomer may be a polybutadiene, a natural rubber, a synthetic polyisoprene, a butadiene copolymer, an isoprene copolymer or a mixture of these elastomers.

I-2. Reinforcing Filler

As another essential feature, the rubber composition of the tread according to the invention comprises between 120 and 140 phr of a silica.

The silica used may be any reinforcing silica known by a person skilled in the art, notably any precipitated or pyrogenic silica having a BET surface area as well as a CTAB specific surface area that are both below 450 m²/g, preferably from 30 to 400 m²/g, notably between 60 and 300 m²/g. As highly dispersible precipitated silicas (called “HDSs”), we may mention for example the silicas “Ultrasil” 7000 and “Ultrasil” 7005 from the company Degussa, the “Zeosil” silicas 1165MP, 1135MP and 1115MP from the company Rhodia, the “Hi-Sil” silica EZ150G from the company PPG, the “Zeopol” silicas 8715, 8745 and 8755 from the company Huber, and the silicas with high specific surface area as described in application WO 03/16387.

A person skilled in the art will understand that as equivalent silica filler described in the present paragraph, it would be possible to use a reinforcing filler of a different kind, notably organic such as carbon black, since this reinforcing filler would be covered with a silica. As an example, we may mention for example carbon blacks for tyres as described for example in patent documents WO 96/37547, WO 99/28380.

Advantageously, the level of silica is in a range from 125 to 135 phr.

According to one embodiment of the invention, the rubber composition of the tread according to the invention may comprise carbon black. Carbon black, when it is present, is preferably used at a level below 20 phr, more preferably below 10 phr (for example between 0.5 and 20 phr, notably between 2 and 10 phr). In the stated ranges, we benefit from the colouring properties (black pigmenting agent) and anti-UV properties of the carbon blacks, though without adversely affecting the typical performance supplied by the inorganic reinforcing filler.

For coupling the silica to the diene elastomer, a coupling agent is used in a well-known way, generally a silane (or bonding agent) intended to provide a sufficient connection, of a chemical and/or physical nature, between the inorganic filler (surface of its particles) and the diene elastomer. This coupling agent is at least bifunctional. At least bifunctional organosilanes or polyorganosiloxanes are used in particular.

Notably polysulphurized silanes are used, called “symmetric” or “asymmetric” depending on their particular structure, as described for example in applications W003/002648 (or US 2005/016651) and WO03/002649 (or US 2005/016650).

Without the following definition being limiting, polysulphurized silanes corresponding to the following general formula (I) are suitable in particular:

Z-A-Sₓ-A-Z, in which: (I)
x is an integer from 2 to 8 (preferably from 2 to 5);
the symbols A, which may be identical or different, represent a divalent hydrocarbon radical (preferably a C₁-C₁₈ alkylene group or a C₆-C₁₂ arylene group, more particularly a C₁-C₁₀, notably C₁-C₄, alkylene, in particular propylene);
the symbols Z, which may be identical or different, correspond to one of the following three formulae:

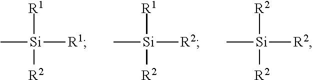

in which:
the radicals R′, which may be substituted or unsubstituted, and may be identical or different, represent a C₁-C₁₈ alkyl, C₅-C₁₈ cycloalkyl or C₆-C₁₈ aryl group (preferably C₁-C₆ alkyl, cyclohexyl or phenyl groups, notably C₁-C₄ alkyl groups, more particularly methyl and/or ethyl);
the radicals R², which may be substituted or unsubstituted, and may be identical or different, represent a C₁-C₁₈ alkoxy or C₅-C₁₈ cycloalkoxyl group (preferably a group selected from C₁-C₈ alkoxyls and C₅-C₈ cycloalkoxyls, even more preferably a group selected from C₁-C₄ alkoxyls, in particular methoxy and ethoxy).

In the case of a mixture of polysulphurized alkoxysilanes corresponding to formula (I) above, notably the usual commercially available mixtures, the average value of “x” is a fractional number preferably between 2 and 5, more preferably close to 4. But the invention may also be carried out advantageously for example with disulphurized alkoxysilanes (x=2).

As examples of polysulphurized silanes, we may mention more particularly the polysulphides (notably disulphides, trisulphides or tetrasulphides) of bis(alkoxy(C₁-C₄)-alkyl(C₁-C₄)silyl-alkyl(C₁-C₄)), for example the polysulphides of bis(3-trimethoxysilylpropyl) or of bis(3-triethoxysilylpropyl). Among these compounds, bis(3-triethoxysilylpropyl) tetrasulphide, abbreviated to TESPT, of formula [(C₂H₅O)₃Si(CH₂)₃S₂]₂ or bis(triethoxysilylpropyl) disulphide, abbreviated to TESPD, of formula [(C₂H_{S}O)₃Si(CH₂)₃S]₂, are used in particular. We may also mention, as preferred examples, the polysulphides (notably disulphides, trisulphides or tetrasulphides) of bis(monoalkoxyl(C₁-C₄)-dialkyl(C₁-C₄)silylpropyl), more particularly bis-monoethoxydimethylsilylpropyl tetrasulphide as described in the aforementioned patent application WO 02/083782 (or U.S. Pat. No. 7,217,751).

As examples of coupling agents other than a polysulphurized alkoxysilane, we may notably mention bifunctional POS (polyorganosiloxanes) or hydroxysilane polysulphides (R²═OH in formula I above) as described for example in patent applications WO 02/30939 (or U.S. Pat. No. 6,774,255), WO 02/31041 (or US 2004/051210), and WO2007/061550, or else silanes or POS bearing azo-dicarbonyl functional groups, as described for example in patent applications WO 2006/125532, WO 2006/125533, WO 2006/125534.

As examples of other sulphurized silanes, we may mention for example the silanes bearing at least one thiol function (—SH) (called mercaptosilanes) and/or at least one blocked thiol function, as described for example in the patents or patent applications U.S. Pat. No. 6,849,754, WO 99/09036, WO 2006/023815, WO 2007/098080.

Of course, mixtures of the coupling agents described above could also be used, as described notably in the aforementioned application WO 2006/125534.

The content of coupling agent is advantageously below 20 phr, it being understood that it is in general desirable to use as little of it as possible. Typically the level of coupling agent represents from 0.5 to 15 wt % relative to the amount of silica. Its level is preferably between 0.5 and 15 phr, and more preferably between 3 and 12 phr. This level is easily adjusted by a person skilled in the art depending on the level of silica used in the composition.

I-3. Plasticizer System:

Another essential feature of the rubber composition of the tread according to the invention is that it comprises a special plasticizer system, comprising, according to a content A ranging from 5 to 60 phr, a hydrocarbon-containing resin having a Tg above 20° C., and according to a content B ranging from 0 to 60 phr, a liquid plasticizer, it being understood that the total level A+B is at least equal to 60 phr.

The designation “resin” is reserved in the present application, by the definition known to a person skilled in the art, to a compound that is solid at room temperature (23° C.), in contrast to a liquid plasticizer such as an oil.

The hydrocarbon-containing resins are polymers familiar to a person skilled in the art, essentially based on carbon and hydrogen but possibly also comprising other types of atoms, usable in particular as plasticizers or tackifiers in polymer matrices. They are by nature miscible (i.e. compatible), at the levels used, with the polymer compositions for which they are intended, so that they act as true diluting agents. They are described for example in the work with the title “Hydrocarbon Resins” by R. Mildenberg, M. Zander and G. Collin (New York, VCH, 1997, ISBN 3-527-28617-9), chapter 5 of which considers their applications, notably in tyre rubber (5.5. “Rubber Tires and Mechanical Goods”). They may be aliphatic, cycloaliphatic, aromatic, hydrogenated aromatic, of the aliphatic/aromatic type, i.e. based on aliphatic and/or aromatic monomers. They may be natural or synthetic, petroleum-based or not (if they are, they are also known as petroleum resins). Their Tg is preferably above 0° C., notably above 20° C. (most often between 30° C. and 95° C.).

As is known, these hydrocarbon-containing resins may also be described as thermoplastic resins, in the sense that they are softened by heating and may thus be moulded. They may also be defined by a softening point. The softening point of a hydrocarbon-containing resin is generally about 50 to 60° C. above its Tg value. The softening point is measured according to standard ISO 4625 (“Ring and Ball” method). The macrostructure (Mw, Mn and PDI) is determined by size exclusion chromatography (SEC) as indicated below.

As a reminder, SEC analysis, for example, consists of separating the macromolecules in solution according to their size through columns filled with a porous gel; the molecules are separated according to their hydrodynamic volume, the most voluminous being eluted first. The sample to be analysed is simply dissolved beforehand in a suitable solvent, tetrahydrofuran at a concentration of 1 g/litre. Then the solution is filtered on a filter of porosity 0.45 μm, before injection into the equipment. The equipment used is for example a “Waters alliance” chromatographic chain according to the following conditions:
elution solvent: tetrahydrofuran,
temperature 35° C.;
concentration 1 g/litre;
flow rate: 1 ml/min;
volume injected: 100 μl;
Moore calibration with polystyrene standards;
set of 3 “Waters” columns in series (“Styragel HR4E”, “Styragel HR1” and “Styragel HR 0.5”);
detection by differential refractometer (for example “WATERS 2410”), which may be equipped with operating software (for example “Waters Millenium”).

A Moore calibration is carried out with a series of commercial standards of polystyrene with low PDI (below 1.2), of known molecular weights, covering the range of molecular weights to be analysed. The weight-average molecular weight (Mw), the number-average molecular weight (Mn), and the polydispersity index (PDI=Mw/Mn), are found from the data recorded (weight distribution curve of the molecular weights).

All the values of molecular weights indicated in the present application therefore relate to calibration curves obtained with polystyrene standards.

According to a preferred embodiment of the invention, the hydrocarbon-containing resin has at least any one, more preferably all of the following characteristics:
a Tg above 25° C. (in particular between 30° C. and 100° C.), more preferably above 30° C. (in particular between 30° C. and 95° C.);
a softening point above 50° C. (in particular between 50° C. and 150° C.);
a number-average molecular weight (Mn) between 400 and 2000 g/mol, preferably between 500 and 1500 g/mol;
a polydispersity index (PDI) below 3, preferably below 2 (reminder: PDI=Mw/Mn where Mw is the weight-average molecular weight).

As examples of these hydrocarbon-containing resins, we may mention the cyclopentadiene homopolymer or copolymer resins (abbreviated to CPD), the dicyclopentadiene homopolymer or copolymer resins (abbreviated to DCPD), the terpene homopolymer or copolymer resins, the C5-cut homopolymer or copolymer resins, the C9-cut homopolymer or copolymer resins, the alpha-methylstyrene homopolymer or copolymer resins or mixtures of these resins. Among the above copolymer resins, we may mention more particularly the (D)CPD/vinyl aromatic copolymer resins, the (D)CPD/terpene copolymer resins, the terpene phenol copolymer resins, the (D)CPD/C5-cut copolymer resins, the (D)CPD/C9-cut copolymer resins, the terpene/vinyl aromatic copolymer resins, the terpene/phenol copolymer resins, the C5-cut/vinyl aromatic copolymer resins, or mixtures of these resins.

Here, the term “terpene” covers, in a known manner, the alpha-pinene, beta-pinene and limonene monomers; a limonene monomer is preferably used, a compound that occurs in a known manner in the form of three possible isomers: L-limonene (laevorotatory enantiomer), D-limonene (dextrorotatory enantiomer), or else dipentene, racemate of the dextrorotatory and laevorotatory enantiomers. Suitable vinyl aromatic monomers are for example styrene, alpha-methylstyrene, ortho-methylstyrene, meta-methylstyrene, para-methyl styrene, vinyl-toluene, para-tert-butyl styrene, the methoxystyrenes, the chlorostyrenes, the hydroxystyrenes, vinyl mesitylene, divinylbenzene, vinyl naphthalene, any vinyl aromatic monomer derived from a C₉ cut (or more generally from a C₈ to C₁₀ cut).

More particularly, we may mention the (D)CPD homopolymer resins, the (D)CPD/styrene copolymer resins, the polylimonene resins, the limonene/styrene copolymer resins, the limonene/D(CPD) copolymer resins, the C5-cut/styrene copolymer resins, the C5-cut/C9-cut copolymer resins, or mixtures of these resins.

All the above resins are familiar to a person skilled in the art and are available commercially, for example sold by the company DRT under the name “Dercolyte” for the polylimonene resins, by the company Neville Chemical Company under the name “Super Nevtac”, by Kolon under the name “Hikorez” or by the company Exxon Mobil under the name “Escorez” for the C5-cut/styrene resins or C5-cut/C9-cut resins, or by the company Struktol under the name “40 MS” or “40 NS” (mixtures of aromatic and/or aliphatic resins).

According to any one of the embodiments of the invention, the resin is preferably a terpene resin such as a homopolymer or a copolymer of limonene, or else a copolymer of C5 cut and of C9 cut.

The liquid plasticizer preferably has a glass transition temperature below −20° C., more preferably below −40° C.

Any extender oil, whether of aromatic or non-aromatic nature, or any liquid plasticizer known for its plasticizer properties with respect to diene elastomers, may be used as liquid plasticizer. At room temperature (23° C.), these plasticizers or these oils, of varying viscosity, are liquid (i.e., as a reminder, substances having the capacity to take on the shape of their container), notably in contrast to the hydrocarbon-containing plasticizing resins, which by nature are solid at room temperature.

Particularly suitable liquid plasticizers are the naphthenic oils, the paraffinic oils, the DAE oils, the MES (Medium Extracted Solvates) oils, the TDAE (Treated Distillate Aromatic Extracts) oils, the RAE (Residual Aromatic Extract) oils, the TRAE (Treated Residual Aromatic Extract) oils and the SRAE (Safety Residual Aromatic Extract) oils, mineral oils, vegetable oils, ether plasticizers, ester plasticizers, phosphate plasticizers, sulphonate plasticizers and mixtures of these compounds.

According to any one of the embodiments of the invention, the liquid plasticizer is preferably a vegetable oil or glycerol trioleate. Notably, a vegetable oil rich in oleic acid is quite particularly suitable, i.e. the fatty acid (or all of the fatty acids if several are present) from which it is derived comprises oleic acid according to a mass fraction at least equal to 60%, preferably according to a mass fraction at least equal to 70%, more preferably at least equal to 80%. As a vegetable oil that is suitable, we may mention a sunflower oil that is such that all of the fatty acids from which it is derived comprise oleic acid according to a mass fraction greater than or equal to 60%, preferably greater than or equal to 70% and, according to a particularly advantageous embodiment of the invention, according to a mass fraction greater than or equal to 80%. When all of the fatty acids from which it is derived comprise oleic acid according to a mass fraction above 80%, the sunflower oil is called oleic sunflower oil.

As an alternative to vegetable oil, glycerol trioleate, a fatty acid triester that is generally present in sunflower oil, may be used as liquid plasticizer.

According to any one of the embodiments of the invention, the total level A+B of hydrocarbon-containing resin and liquid plasticizer is preferably in a range from 60 to 90 phr, more preferably in a range from 60 to 80 phr.

According to a preferred embodiment of the invention, the level A of hydrocarbon-containing resin is in a range from 35 to 60 phr and the level B of liquid plasticizer is in a range from 0 to 35 phr. More preferably A is greater than 40 phr and less than or equal to 60 phr and B is in a range from 0 to 30 phr.

According to another preferred embodiment of the invention, the level of liquid plasticizer is between 15 and 30 phr.

According to a particular embodiment of the invention, the ratio of A to B is greater than 1, preferably greater than or equal to 2.

According to another particular embodiment of the invention, the weight ratio of (A+B) to the weight of inorganic reinforcing filler, notably silica, is in a range from 40 to 60%, preferably from 50 to 60%.

I-4. Various Additives:

The rubber compositions of the tyre treads according to the invention may also comprise some or all of the usual additives usually employed in the compositions of elastomers intended for the manufacture of tyre treads, notably tyres, fillers other than those mentioned above, for example non-reinforcing fillers such as chalk or else lamellar fillers such as kaolin, talc, pigments, protective agents such as anti-ozone waxes, chemical anti-ozone agents, antioxidants, reinforcing resins (such as resorcinol or bismaleimide), acceptors (for example novolac phenolic resin) or methylene donors (for example HMT or H3M) as described for example in application WO 02/10269, a crosslinking system based either on sulphur, or donors of sulphur and/or of peroxide and/or of bismaleimides, vulcanization accelerators or retarders, vulcanization activators.

These compositions may also contain coupling activators when a coupling agent is used, agents for covering the inorganic filler or more generally application aids that are able, in a known manner, owing to improvement of the dispersion of the filler in the rubber matrix and to lowering of the viscosity of the compositions, to improve their usability in the raw state; these agents are for example hydrolysable silanes such as alkyl-alkoxysilanes, polyols, polyethers, amines, hydroxylated or hydrolysable polyorganosiloxanes.

I-5. Preparation of the Rubber Compositions:

The compositions used in the tyre treads of the invention may be manufactured in suitable mixers, using two successive steps of preparation familiar to a person skilled in the art: a first working step or thermomechanical kneading (the so-called “non-productive” step) at high temperature, up to a maximum temperature between 110° C. and 190° C., preferably between 130° C. and 180° C., followed by a second step of mechanical work (so-called “productive” step) up to a lower temperature, typically below 110° C., for example between 40° C. and 100° C., the finishing step during which the crosslinking system is incorporated.

The method for preparing such compositions comprises for example the following steps:
thermomechanically kneading (for example once or more than once) the first diene elastomer, the silica, the coupling agent, the plasticizer system, until a maximum temperature between 110° C. and 190° C. is reached (so-called “non-productive” step);
cooling the whole to a temperature below 100° C.;
then incorporating, during a second step (so-called “productive” step), a crosslinking system;
kneading the whole up to a maximum temperature below 110° C.

As an example, the non-productive step is carried out in a single thermomechanical step during which firstly all the main constituents (the diene elastomer or elastomers, the plasticizer system, the inorganic reinforcing filler and the coupling agent) are put in a suitable mixer such as an ordinary internal mixer, then secondly, for example after kneading for one to two minutes, the other additives, optional additional agents for covering the filler or aids, apart from the crosslinking system are added. The total duration of kneading, in this non-productive step, is preferably between 1 and 15 min.

After the mixture thus obtained has cooled, the crosslinking system is then incorporated in an external mixer such as an open mill, maintained at low temperature (for example between 40° C. and 100° C.). The whole is then mixed (productive step) for some minutes, for example between 2 and 15 min.

The crosslinking system proper is preferably based on sulphur and a primary vulcanization accelerator, in particular an accelerator of the sulphenamide type. Various known secondary accelerators or vulcanization activators such as zinc oxide, stearic acid, guanidine derivatives (in particular diphenylguanidine), etc., will be added to this vulcanization system, incorporated during the first non-productive step and/or during the productive step. The level of sulphur is preferably between 0.5 and 3.0 phr, and that of the primary accelerator is preferably between 0.5 and 5.0 phr.

Any compound that can act as an accelerator of the vulcanization of diene elastomers in the presence of sulphur, notably accelerators of the thiazole type as well as their derivatives, accelerators of the thiuram type, zinc dithiocarbamates, may be used as accelerator (primary or secondary). These accelerators are more preferably selected from the group consisting of 2-mercaptobenzothiazyl disulphide (abbreviated to “MBTS”), N-cyclohexyl-2-benzothiazyl sulphenamide (abbreviated to “CBS”), N,N-dicyclohexyl-2-benzothiazyl sulphenamide (abbreviated to “DCBS”), N-tert-butyl-2-benzothiazyl sulphenamide (abbreviated to “TBBS”), N-tert-butyl-2-benzothiazyl sulphenimide (abbreviated to “TBSI”), zinc dibenzyldithiocarbamate (abbreviated to “ZBEC”) and mixtures of these compounds. Preferably, a primary accelerator of the sulphenamide type is used.

The final composition thus obtained may then be calendered, for example in the form of a sheet or a plate notably for characterization in the laboratory, or else extruded, for example to form a rubber profile used for manufacture of a tyre tread, notably for a passenger vehicle.

The invention relates to the treads described above both in the raw state (i.e. before curing) and in the cured state (i.e., after crosslinking or vulcanization).

The invention also relates to a method for preparing the tread according to the invention, said method comprising the following steps:
thermomechanically kneading the first diene elastomer, silica, coupling agent, plasticizer system, until a maximum temperature between 110° C. and 190° C. is reached;
cooling the whole to a temperature below 100° C.;
then, in a second step, incorporating a crosslinking system;
kneading the whole up to a maximum temperature below 110° C.;
calendering or extruding the composition thus obtained.

The invention also relates to tyres that comprise a tread described above.

The invention also applies to the case when the rubber compositions described above form just a part of treads of the composite or hybrid type, notably those consisting of two radially superposed layers of different formulations (so-called “cap-base” structure), both sculpted and intended to come into contact with the road during rolling of the tyre, for the life of the latter. The part based on the formulation described above can then constitute the radially outer layer of the tread intended to come into contact with the ground right from the start of rolling of the new tyre, or conversely its radially inner layer intended to come into contact with the ground subsequently.

### II—EMBODIMENT EXAMPLES OF THE INVENTION

II.1—Preparation of compositions C1, C2, C3 and C4:

The formulations (in phr) of compositions C1, C2, C3 and C4 are described in Table I.

Composition C1, according to the invention, is characterized by an elastomer matrix that comprises more than 50 wt % of an SBR bearing a silanol function and an amine function, notably tertiary, these functions being positioned away from the ends of the elastomer chain. Composition C1 also contains 130 phr of silica, 23 phr of oleic sunflower oil and 47 phr of polylimonene resin. In this composition the level A+B is equal to 70 phr, greater than 45 phr.

Composition C2, not according to the invention, differs from C1 only by the nature of the elastomer that constitutes the elastomer matrix. The elastomer matrix of composition C2 comprises more than 50 wt % of an elastomer bearing a silanol function at the end of the elastomer chain.

Compositions C3 and C4 are not according to the invention, as the level of filler is 110 phr in C3 and C4 and the elastomer bears a silanol function at the end of the chain in C4.

Manufacture of these compositions is carried out in the following way: the elastomers, silica, coupling agent, the plasticizers as well as the various other ingredients apart from the vulcanization system are introduced successively into an internal mixer (final filling level: about 70 vol %), whose initial tank temperature is about 60° C. Then thermomechanical working (non-productive step) is carried out in one step, which takes a total of 5 min, until a maximum “dropping” temperature of 165° C. is reached.

The mixture thus obtained is recovered, it is cooled and then sulphur and an accelerator of the sulphenamide type are incorporated in a mixer (homo-finisher) at 23° C., mixing the whole (productive step) for a suitable time (for example between 5 and 12 min).

The properties of compositions C1 and C2 after curing are shown in Table II.

II.2—Results:

The results are shown in Table II.

The dynamic properties tan(δ)max are measured on a viscoanalyser (Metravib VA4000), according to standard ASTM D 5992-96. The response of a sample of vulcanized composition (cylindrical test specimen with thickness of 4 mm and cross-section of 400 mm²), submitted to sinusoidal stressing in alternating simple shear, at a frequency of 10Hz, at 0° C. or at 100° C., is recorded.

For the measurements at 100° C., a deformation amplitude scan is performed from 0 to 50% (forward cycle), and then from 50% to 0% (return cycle). For the return cycle, the maximum value of tan(δ) observed, tan(δ)ₘₐₓ, is measured. The higher the value of tan(δ)ₘₐₓ at 100° C., the better the grip of the tyre on dry ground.

For the measurements at 0° C., a deformation amplitude scan is performed under constant stress at 0.7 MPa. The higher the value of tan(δ) at 0° C., the better the grip of the tyre on wet ground.

The results show that composition C1 according to the invention has an improved compromise of performance between wet grip and dry grip, compared to composition C2 not according to the invention. In fact composition C1 has values of tanδ at 0° C. and at 100° C. that are both higher than those of composition C2.

It can be seen that the improvement of this compromise cannot be obtained if the combination based on the choice of a specific functional elastomer and a specific level of filler combined with a plasticizer system is not according to the invention. In fact it can be seen that at a level of filler not according to the invention, in the present case 110 phr, both the values of tanδ at 0° C. and at 100° C. of composition C3 are well below those of composition C1. The same finding is made for composition C4 not according to the invention. It can even be seen that composition C3 is less interesting than composition C4 from the standpoint of the compromise of performance between wet grip and dry grip, the values of tanδ at 0° C. and at 100° C. being lower than those of composition C4.

The improvement of the compromise of performance between wet grip and dry grip is made possible by the judicious choice of the functional elastomer and of the level of silica combined with a plasticizer system. Such a result is unexpected.

TABLE I

| | Composition No.: | | | |
|---|---|---|---|---|
| | | C2 | C3 | |
| | C1 | not | not | C4 |
| | according | according | according | not according |
| | to the | to the | to the | to the |
| | invention | invention | invention | invention |
| SBR1 (1) | 100 | — | 100 | — |
| SBR2 (2) | — | 100 | — | 100 |
| Carbon black (3) | 3 | 3 | 3 | 3 |
| Silica (4) | 130 | 130 | 110 | 110 |
| Coupling agent (5) | 10 | 10 | 10 | 10 |
| Liquid | 23 | 23 | 37 | 37 |
| plasticizer (6) | | | | |
| Resin (7) | 47 | 47 | 20 | 20 |
| Stearic acid | 3 | 3 | 3 | 3 |
| Anti-ozone wax | 2 | 2 | 2 | 2 |
| Antioxidant (8) | 3 | 3 | 3 | 3 |
| DPG (9) | 2 | 2 | 2 | 2 |
| ZnO | 1 | 1 | 1 | 1 |
| Accelerator (10) | 2 | 2 | 2 | 2 |
| Sulphur | 1 | 1 | 1 | 1 |

(1) SBR1: SBR with 27% of styrene unit and 24% of unit 1, 2 of the butadiene moiety (Tg = −48° C.) bearing a silanol function and a tertiary amine pendent function, said functions being situated for the greater part of the weight of the elastomer chains (more than 50 wt % of the weight of elastomer) away from the ends of the elastomer chain;
(2) SBR with 27% of styrene unit and 24% of unit 1, 2 of the butadiene moiety (Tg = −48° C.) bearing a silanol function at the end of the elastomer chain
(3) Grade ASTM N234 (Cabot company);
(4) Silica “Zeosil 1165 MP” from the company Rhodia type “HDS”
(5) TESPT (“Si69” from the company Degussa);
(6) Sunflower oil at 85 wt % of oleic acid, “Lubrirob Tod 1880” from the company Novance
(7) C5/C9 ECR-373 resin from the company Exxon;
(8) N-(1,3-Dimethylbutyl)-N′-phenyl-p-phenylenediamine, from the company Flexsys
(9) Diphenylguanidine (“Perkacit” DPG from the company Flexsys);
(10) N-Cyclohexyl-2-benzothiazole-sulphenamide (“Santocure CBS” from the company Flexsys).

TABLE II

Composition No.:

| | C1 | C2 | C3 | C4 |
|---|---|---|---|---|
| tanδ at 0° C. | 0.728 | 0.705 | 0.333 | 0.354 |
| tanδₘₐₓ at 100° C. | 0.168 | 0.164 | 0.155 | 0.156 |

1.-19. (canceled)

20. A tire tread comprising a rubber composition based on at least:
an elastomer matrix comprising more than 50 wt % of a first diene elastomer bearing a silanol function and a pendent amine function,
a silica at a level between 120 and 140 phr;
a coupling agent; and
a plasticizer system comprising:
a hydrocarbon-containing resin having a Tg above 20° C. according to a content A ranging from 5 to 60 phr; and
a liquid plasticizer according to a content B ranging from 0 to 60 phr,
where the total level A+B is at least equal to 60 phr.

21. The tire tread according to claim 20, wherein the total level A+B ranges from 60 to 90 phr.

22. The tire tread according to claim 20, wherein the silanol function and the pendent amine function are situated away from the chain ends of the first diene elastomer.

23. The tire tread according to claim 20, wherein the first diene elastomer is a diene elastomer obtainable by a coupling reaction with a coupling agent bearing an alkoxysilane function and an amine function, followed by hydrolysis of the alkoxysilane function into a silanol function.

24. The tire tread according to claim 20, wherein the first diene elastomer is an SBR.

25. The tire tread according to claim 24, wherein the first diene elastomer is a solution SBR.

26. The tire tread according to claim 24, wherein the first diene elastomer is a copolymer of a diene and a vinyl aromatic and has a glass transition temperature between −55° C. and −40° C.

27. The tire tread according to claim 20, wherein the amine function is a tertiary amine function.

28. The tire tread according to claim 20, wherein the amount of star chains and of branched chains present in the first diene elastomer is in a range from 0 wt % to less than 50 wt % of the total weight of the first diene elastomer.

29. The tire tread according to claim 20, wherein the elastomer matrix comprises more than 75 wt % of the first diene elastomer.

30. The tire tread according to claim 29, wherein the elastomer matrix comprises more than 90 wt % of the first diene elastomer.

31. The tire tread according to claim 20, wherein A is in a range from 35 to 60 phr and B is in a range from 0 to 35 phr.

32. The tire tread according to claim 31, wherein A is greater than 40 phr and less than or equal to 60 phr and B is in a range from 0 to 30 phr.

33. The tire tread according to claim 20, wherein B is between 15 and 30 phr.

34. The tire tread according to claim 20, wherein the ratio of A to B is greater than 1.

35. The tire tread according to claim 34, wherein the ratio of A to B is greater than or equal to 2.

36. The tire tread according to claim 20, wherein the hydrocarbon-containing resin is a terpene resin or a copolymer of C5 cut and of C9 cut.

37. The tire tread according to claim 20, wherein the liquid plasticizer is glycerol trioleate or a vegetable oil.

38. The tire tread according to claim 37, wherein the liquid plasticizer is a sunflower oil.

39. The tire tread according to claim 38, wherein the liquid plasticizer is an oleic sunflower oil.

40. The tire tread according to claim 20, wherein the level of silica is from 125 to 135 phr.

41. The tire tread according to claim 20, wherein the weight ratio of A+B to the weight of inorganic reinforcing filler is in a range from 40 to 60%.

42. The tire tread according to claim 41, wherein the weight ratio of A+B to the weight of inorganic reinforcing filler is in a range from 50 to 60%.

43. A tire comprising the tire tread according to claim 20.

44. A method for preparing the tire tread according to claim 20 comprising the steps of:
thermomechanically kneading the first diene elastomer, silica, coupling agent, and plasticizer system until a maximum temperature between 110° C. and 190° C. is reached;
cooling to a temperature below 100° C.;
incorporating a crosslinking system;
kneading to a maximum temperature below 110° C.; and
calendering or extruding the composition thus obtained.
